(19) United States
(12) Patent Application Publication
(10) Pub. No.: US 2006/0079177 A1
(43) Pub. Date: Apr. 13, 2006

(54) Wireless communicatin antenna and wireless communication device

(76) Inventor: Akihiko Okubora, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/540,647

(22) PCT Filed: Dec. 11, 2003
(86) PCT No.: PCT/JP03/15884

§ 371 Date: Jun. 24, 2005

(30) Foreign Application Priority Data
Dec. 26, 2002 (JP) 2002-378431

(51) Int. Cl. H04B 7/14

(52) U.S. Cl. 455/25

(57) ABSTRACT

The present invention is directed to a wireless communication apparatus provided at various electronic equipments having wireless communication function, and performs, by a system control unit (6), in accordance with communication band used, a control to select plural communication circuits (4), (5) having communication bands different from each other, which are connected to a wireless communication antenna (1) including plural antenna element patterns connected through switches formed on an antenna board, and having plural resonance frequencies selected by switching connecting state of the antenna element patterns by the switch, and to select resonance frequency of the wireless communication antenna.

### TECHNICAL FIELD

The present invention relates to a wireless communication antenna and a wireless communication apparatus provided at various electronic equipments having wireless communication function, e.g., personal computers, audio equipments, various mobile equipments and/or mobile telephones, etc.

This Application claims priority of Japanese Patent Application No. 2002-378431, filed on Dec. 26, 2002, the entirety of which is incorporated by reference herein.

### BACKGROUND ART

Various information, e.g., music, video and/or image, etc. have been handled with ease also by personal computer and/or mobile computer, etc. with digitization of data. Band compression of these information has been realized by the sound codec technology and/or image codec technology. Thus, there is being arranged the environment where the band-compressed information are easily and efficiently distributed (delivered) to various communication terminal units by the digital communication or the digital broadcasting service. For example, audio/video data (AV data), etc. not only can be received by wire, but also can be received at the outdoor through mobile telephone, etc.

The transmitting/receiving systems for data have been variously utilized by constructing suitable network also within homes and/or small areas. As the network system, there are proposed various next generation wireless network systems such as high speed wireless LAN system for performing data communication at a transmission rate (speed) of 36 to 54 Mbps by using frequency band in the vicinity of 5.2 GHz in conformity with IEEE802. 11a, wireless LAN system for performing communication at a rate (speed) of 11 Mbps by using 2.4 GHz band in conformity with the IEEE802. 11b, and/or short distance wireless communication system called Bluetooth, etc., which are examples of the standards of the wireless LAN that the 802 committee which has decided the standards of LAN technology by IEEE (Institute of Electrical and Electronics Engineers, Inc.).

In the transmitting/receiving system for data, etc., such wireless network systems are effectively utilized so that transfer of data, access to Internet and/or transmission/reception of data can be made with ease and without intervention of relay device, etc. at various places such as home or outdoor, etc.

On the other hand, in the transmitting/receiving system for data, etc. also as described in the Japanese Patent Application Laid Open No. 2002-280745 publication, realization of small, light and portable communication terminals having the above-described communication function is indispensable.

Meanwhile, various communication systems have been conventionally proposed to selectively use plural communication systems so that selective communication can be made.

For example, in the areas of LAN (Local Area Network) and/or PAN (Personal Area Network), multi-band communication units of the IEEE802. 11b and IEEE802. 11a, etc. are being commercialized. However, in the system such as IEEE802. 11a, etc. having high communication rate (speed), since power consumption is large, and dual band antenna, etc. is also larger than ordinary antenna, such antenna was not suitable for mounting with respect to portable (mobile) equipments, etc.

Also in portable (mobile) electronic equipments such as PDA (Personal Digital Assistant) or mobile telephone, etc., there exists use purpose where there is a desire to download large file via Internet. Realization of such use purpose was impossible.

### DISCLOSURE OF THE INVENTION

An object of the present invention is to provide a novel wireless communication antenna and a novel wireless communication apparatus which can solve problems that prior arts as described above have.

Another object of the present invention is to provide a wireless communication antenna and a wireless communication apparatus which permit system configuration and hardware configuration in which in the case where there is a margin in battery, or when power can be directly supplied from commercial power supply even in the case of portable (mobile) equipments, communication of high communication rate is selected, while when there is a desire to save power supply at the time of outgoing, etc., setting into low power consumption mode can be automatically made.

The wireless communication antenna according to the present invention includes plural antenna element patterns connected through a switch or switches formed on an antenna board, and has plural resonance frequencies selected by switching connecting state of the antenna element patterns by the switch or switches.

In the wireless communication antenna according to the present invention, the switch is comprised of, e.g., MEMS switch element, and is buried into antenna board comprised of multi-layer substrate.

The wireless communication apparatus according to the present invention comprises: a wireless communication antenna including plural antenna element patterns connected through a switch or switches formed on an antenna board, and having plural resonance frequencies selected by switching connecting state of the antenna element patterns by the switch or switches; plural communication circuits having communication bands different from each other, which are connected to the wireless communication antenna; and a control unit for performing, in accordance with a communication band used, a control to select the communication circuit, and to select the resonance frequency of the wireless communication antenna.

In the wireless communication apparatus according to the present invention, the control unit performs a control to automatically determine the communication band used in accordance with, e.g., operation mode which can be set in advance to select the communication circuit, and to select the resonance frequency of the wireless communication antenna.

Moreover, the control unit perform a control to automatically determine the communication band used on the basis of, e.g., signal reception intensities obtained by the respective communication circuits to select the communication circuit, and to select the resonance frequency of the wireless communication antenna.

Further, the switch of the wireless communication antenna is comprised of, e.g., MEMS switch element, and is buried in the antenna board comprised of multi-layer substrate.

Still further objects of the present invention and practical merits obtained by the present invention will become more apparent from the description of the embodiments which will be given below with reference to the attached drawings.

### BRIEF DESCRIPTION OF THE DRAWINGS

FIG. 1 is a block diagram showing a wireless communication system to which the present invention is applied.

FIG. 2 is a circuit configuration diagram showing the fundamental configuration of tunable antenna used in the wireless communication system.

FIG. 3 is a plan view showing a configuration example of tunable antenna constituted by using MEMS switch elements.

FIG. 4 is a characteristic diagram showing the state of band tuning of the tunable antenna.

FIG. 5 is an essential part longitudinal cross sectional view showing the structure of MEMS switch element.

FIG. 6 is an essential part plan view showing the structure of the MEMS switch element.

FIGS. 7A to 7D are essential part longitudinal cross sectional views showing the process of mounting of MEMS switch element.

FIGS. 8, 9 and 10 are flowcharts showing control procedure of the wireless communication system by control unit.

FIG. 11 is a plan view showing a configuration example of tunable antenna constituted by mono-pole antenna of the inverted F-type.

FIG. 12 is a plan view showing a configuration example of tunable antenna constituted by antenna of the slot type.

FIG. 13 is a plan view showing a configuration example of tunable antenna constituted by mono-pole antenna having antenna pattern of the spiral shape.

### BEST MODE FOR CARRYING OUT THE INVENTION

Embodiments of the present invention will now be described in detail with reference to the attached drawings.

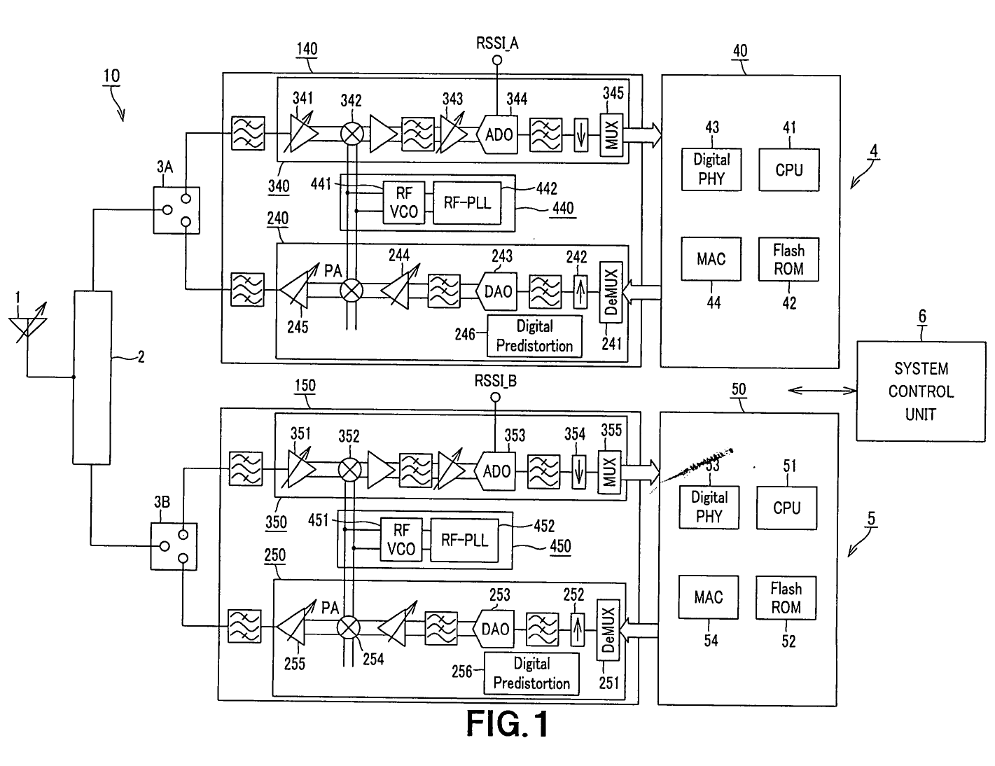

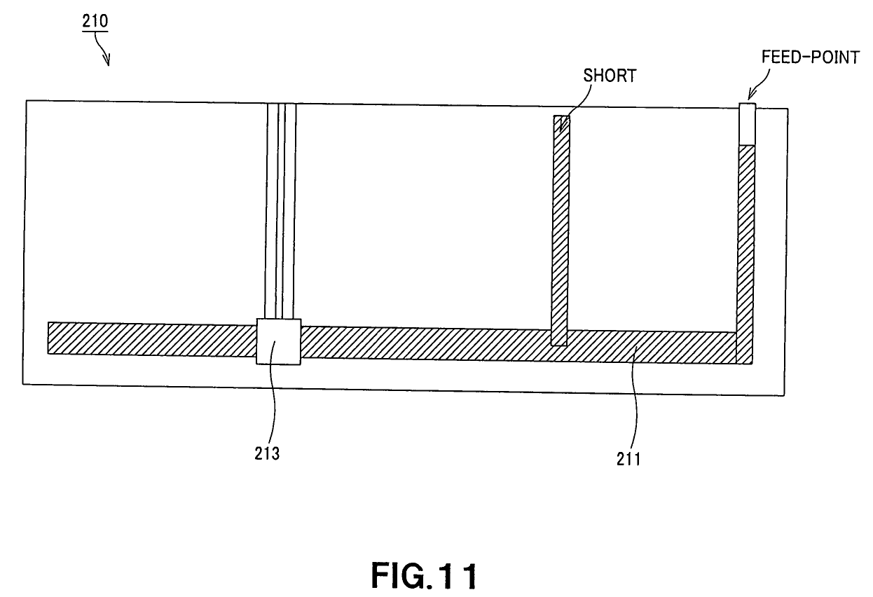

The present invention is applied to a wireless communication system 10 constituted as shown in FIG. 1, for example. The wireless communication system 10 shown in FIG. 11 is a multi-band wireless communication system complying with the IEEE802. 11a and the IEEE802. 11b, and is composed of a tunable antenna 1, a duplexer 2 connected to the tunable antenna 1, first and second transmit/receive changeover switches 3A, 3B which are connected to the duplexer 2, a first transmitting/receiving circuit 4 connected to the duplexer 2 through the first transmit/receive changeover switch 3A, a second transmitting/receiving circuit 5 connected to the duplexer 2 through the second transmit/receive changeover switch 3B, and a system control unit 6 for controlling operations of these circuit components.

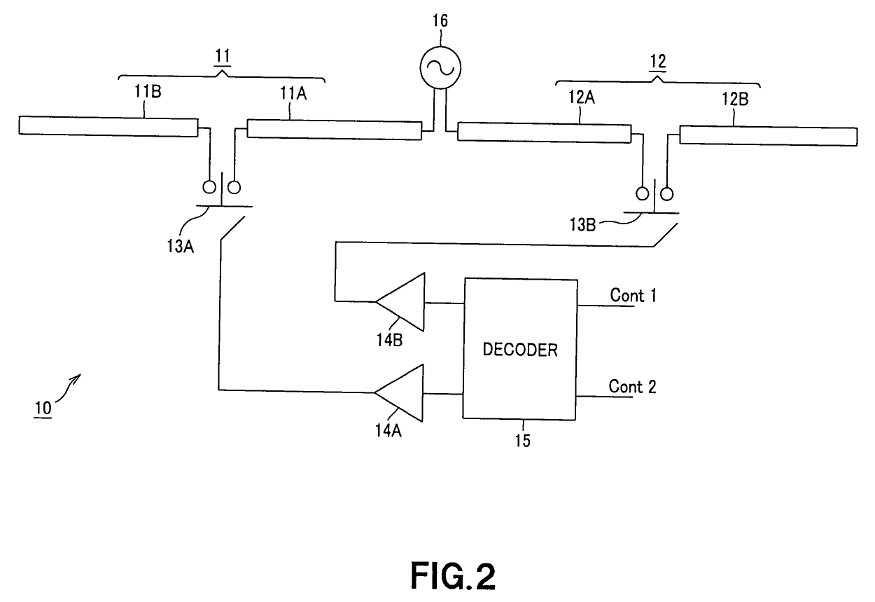

In the tunable antenna 1, as the fundamental configuration thereof is shown in FIG. 2, two antenna elements 11, 12 constituting λ/2 dipole antenna are respectively bisected, and a switch 13A for connecting the bisected antenna elements 11A, 11B therebetween and a switch 13B for connecting the bisected antenna elements 12A, 12B therebetween are provided at the bisected (divisional) positions so that structure resonating at two kinds of frequency bands is provided. In the state where the switches 13A, 13B are opened, the tunable antenna 1 functions as λa/2 dipole antenna resonating at the frequency band of the high frequency band side only by two antenna elements 11A, 12A of feed-point side connected to a RF power feed terminal 16. In the state where the switches 13A, 13B are closed, the tunable antenna 1 functions as λb/2 dipole antenna by the entirety of the antenna elements 11A, 11B, 12A, 12B which have been bisected.

The tunable antenna 1 is caused to be of the structure in which wavelength where resonating operation takes place at 5.2 GHz band is caused to be λa, wavelength where resonating operation is performed at 2.4 GHz band is caused to be λb, lengths of respective antenna elements 11A, 12A of the feed-point side are caused to be λa/4, and antenna elements 11B, 12B having length of (λb−λa)/4 are connected to respective antenna elements 11A, 12A of the feed-point side through the switch 13B, whereby in the state where the switches 13A, 13B are opened, the tunable antenna 1 functions as λa/2 dipole antenna resonating at 5.2 GHz band used for data communication in conformity with the IEEE802. 11a only by two antenna elements 11A, 12A of the feed-point side, while in the state where the switches 13A, 13B are closed, the tunable antenna 1 functions as λb/2 dipole antenna resonating at 2.4 GHz band used for data communication in conformity with the IEEE802. 11b by the entirety of the antenna elements 11A, 11B, 12A, 12B which have been bisected.

As respective switches 13A, 13B, there are respectively used MEMS (Micro-Electro-Mechanical-System) switches.

Control signals (cont1, cont2) are delivered from the system control unit 6 to drivers 14A, 14B for driving the respective switches 13A, 13B through a decoder 15. When the operation mode is communication mode in conformity with the IEEE802. 11a, the respective switches 13A, 13B are placed in opened state. When the operation mode is communication mode inconformity with the IEEE802. 11b, these switches are placed in closed state.

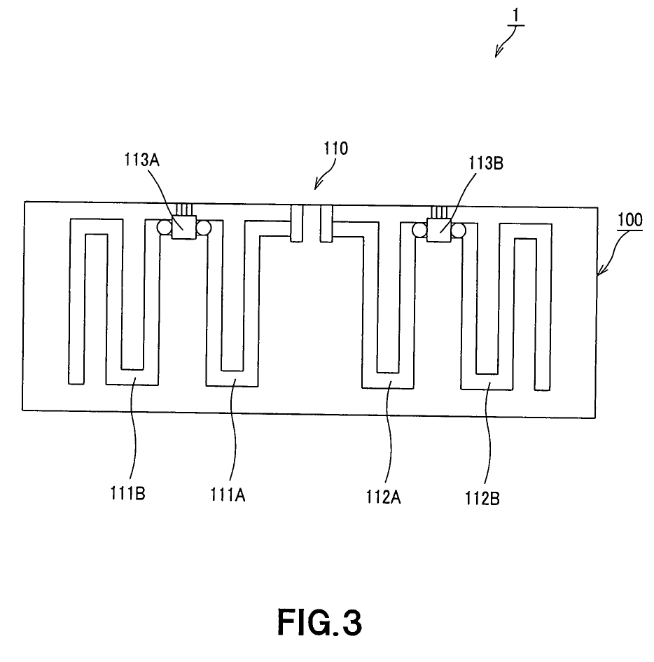

Here, the configuration example of the tunable antenna 1 using MEMS switch elements as respective switches 13A, 13B is shown in FIG. 3.

FIG. 3 shows the configuration example of the tunable antenna 1 in which symmetry-type dipole antenna excited (driven) from feed-point is formed on printed wiring board.

In the tunable antenna 1 shown in FIG. 3, on the principal surface of the antenna board 100, there are provided a power feed terminal section 110, bisected folded pattern-shaped respective antenna element patterns 11A, 111B, 112A, 112B, and MEMS switch elements 113A, 113B located at the bisected positions.

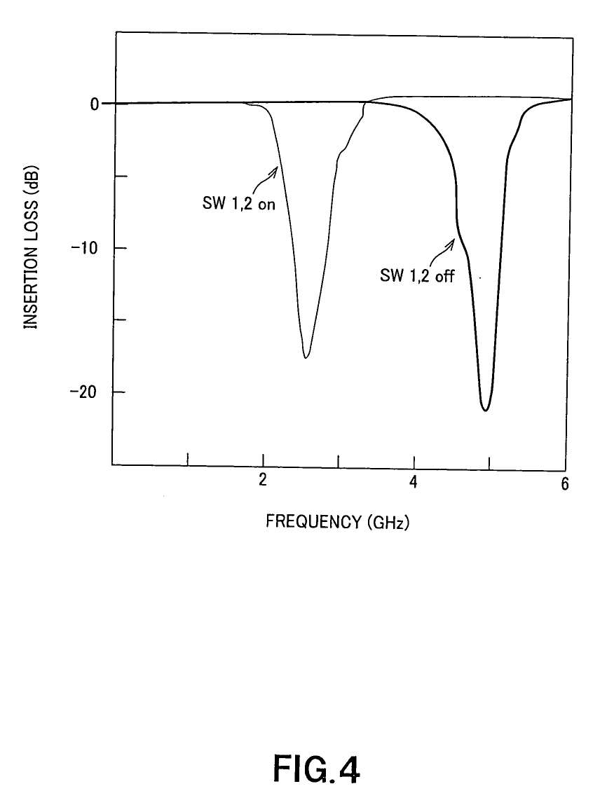

In this example, the length of one side dipole element is approximately ¼λ (substantially Rout(ε) in material having dielectric constant ε). Switching of a desired length is performed by MEMS switch elements 113A, 113B, thereby making it possible to change resonance frequency as shown in FIG. 4.

FIG. 4 shows the state of band tuning of the tunable antenna 1 in which there is formed λ/2 dipole antenna capable of switching resonance band into two kinds of frequency bands of 5.2 GHz band and 2.4 GHz band by the MEMS switch elements (SW1, 2) 113A, 113B. In FIG. 4, the abscissa indicates frequency (GHz), and the ordinate indicates insertion loss (dB). The tunable antenna 1 functions as a dual band antenna in which in the state where MEMS switch elements 113A, 113B are opened, the tunable antenna 1 resonates at 5.2 GHz band, and in the state where the MEMS switch elements 113A, 113B are closed, the tunable antenna 1 resonates at 2.4 GHz band.

Here, since MEMS switch elements 113A, 113B used as respective switches 13A, 13B of the tunable antenna 1 have similar structure, only the structure of the MEMS switch element 113 will be explained.

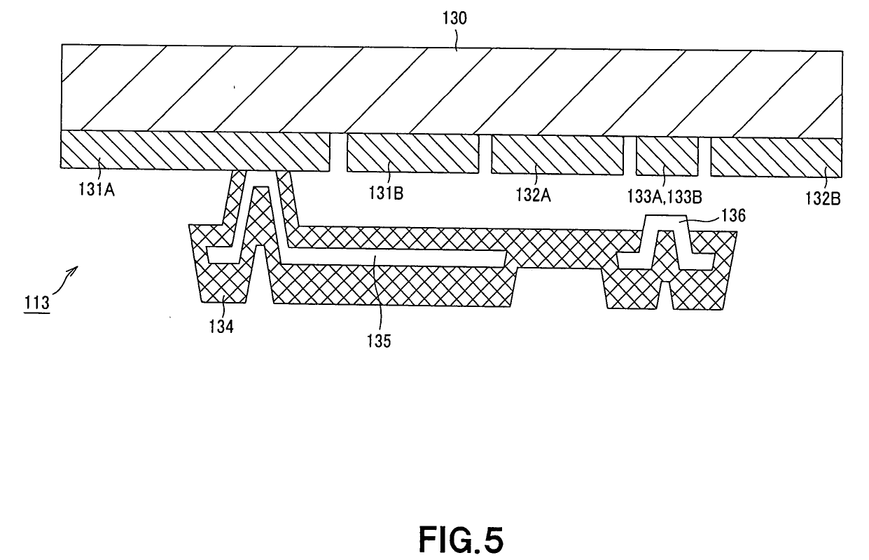

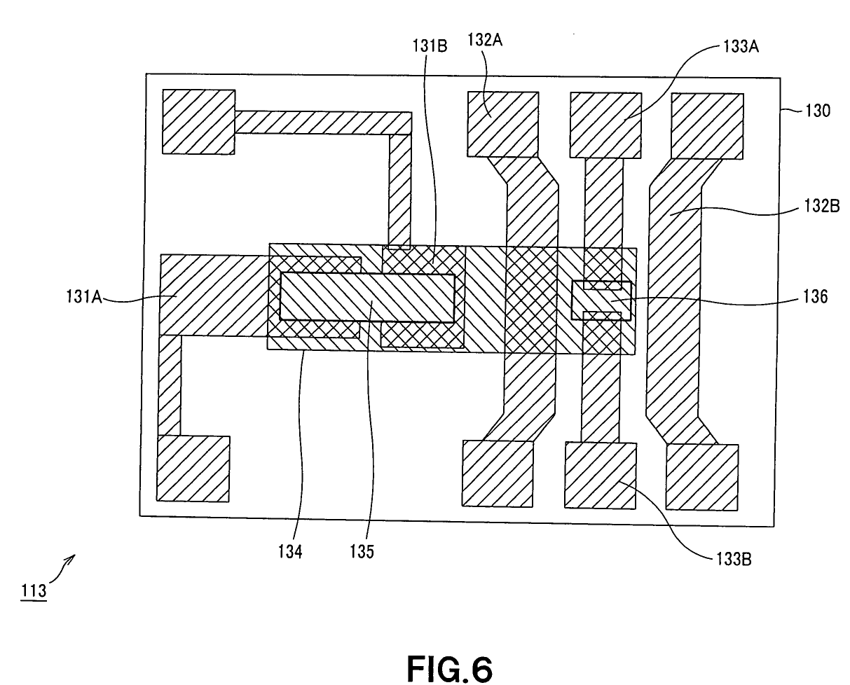

As the essential part longitudinal cross sectional side view is shown in FIG. 5, and the essential part plan view is shown in FIG. 6, the MEMS switch element 113 is composed of a silicon substrate 130 where first and second control electrode patterns 131A, 131B, first and second ground patterns 132A, 132B, and first and second fixed contact electrode patterns 133A, 133B are formed in the state where they are insulated from each other, and a cantilever 134 comprised of thin plate shaped insulating material having elasticity, which is supported in the cantilever state as the result of the fact that one end thereof is fixed at the position of the first control electrode pattern 131A on the silicon substrate 130.

At the cantilever 134, there are provided an opposite electrode pattern 135 electrically connected to the first control electrode pattern 131A and extended up to the position opposite to the second control electrode pattern 131B. In addition, at the free end side thereof, there is provided a movable contact piece 136 in a manner opposite to both the first and second fixed contact electrode patterns 133A, 133B.

In the MEMS switch element 113 of such a structure, when drive signals are delivered from the drivers 14A, 14B to the first and second control electrode patterns 131A, 131B, electrostatic attractive force is produced by drive voltage applied to the opposite portion of the first and second control electrode patterns 131A, 131B. By this attractive force, the cantilever 134 of the cantilever support structure is bent. Thus, as the result of the fact that the movable contact piece 136 provided at the free end portion thereof comes into contact with the first and second fixed contact electrode patterns 133A, 133B, the first and second fixed contact electrode patterns 133A, 133B electrically conduct therebetween through the movable contact piece 136, the MEMS switch element 113 holds the closed state.

Moreover, when drive signals for applying drive voltage of reverse bias are delivered from drivers 14A, 14B to the first and second control electrode patterns 131A, 131B in the closed state, the cantilever 134 returns to the initial state so that the movable contact piece 136 is away from the first and second fixed contact electrode patterns 133A, 133B, the MEMS switch element 113 is placed in closed state.

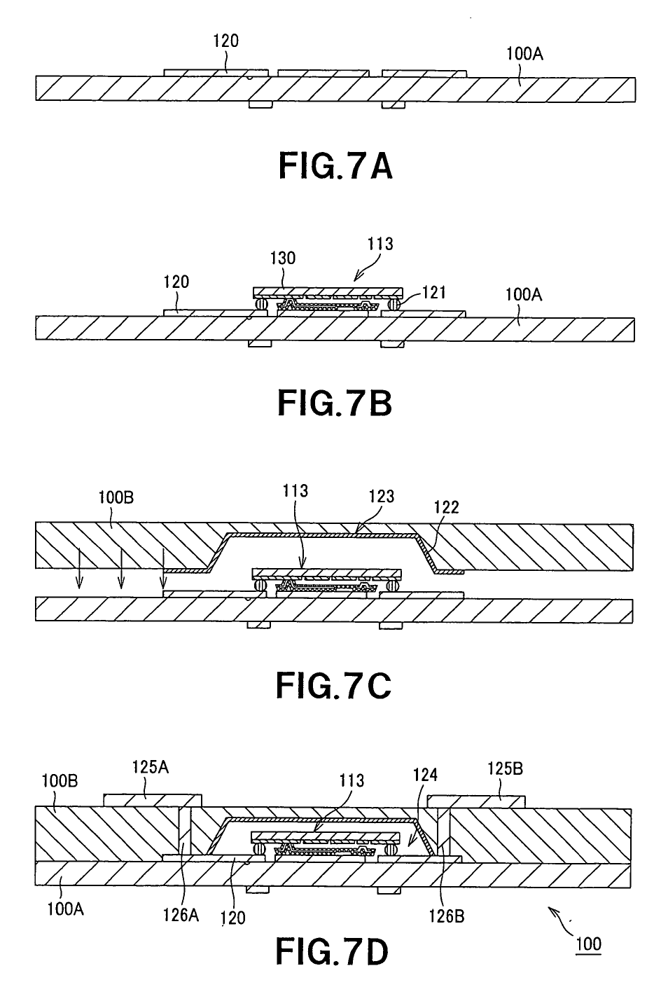

The MEMS switch element 113 is mounted by the processing as described below. Namely, the MEMS switch element 113 is mounted after undergone positioning on an organic base substrate 100A where wiring patterns 120 are formed as shown in FIG. 7A in the state where the silicon substrate 130 is caused to be located at the upper side as shown in FIG. 7B to hold opposite spacing by metallic ball bumps 121. Further, ultrasonic wave is applied while pressurizing the metallic ball bumps 121 on the order of several ten grams in the state where, e.g., the organic base substrate 100A is heated so that its temperature is 80° C. to 120° C. to thereby mount the MEMS switch element 113 on the organic base substrate 100A.

It is to be noted that the method of mounting MEMS switch element 113 is not limited to such ultrasonic flip-chip mounting method, but suitable bare chip mounting method may be employed.

As shown in FIGS. 7C and 7D, a cap substrate 100B where shield pattern 122 is formed is further mounted and bonded on the organic base substrate 100A on which MEMS switch element 113 is mounted in this way.

At the cap substrate 100B, a recessed portion 123 having dimensions sufficient to cover the MEMS switch element 113 is formed at the bonding surface to the organic base substrate 100A. The shield pattern 122 is formed as film at the recessed portion 123 by the MID (Molded Interconnect Device) method or deposition method, etc. for three-dimensionally forming electric circuit patterns with respect to, e.g., resin molded material.

The cap substrate 100B is bonded onto the organic base substrate 100A in a manner as described below.

For example, within inactive gas atmosphere such as nitric box, etc., the organic base substrate 100A and the cap substrate 100B are integrated by, e.g., ultrasonic wave welding method in the state where the cap substrate 100B is overlaid with respect to the organic base substrate 100A after undergone positioning.

By bonding the organic base substrate 100A and the cap substrate 100B within nitrogen box in this way, the organic base substrate 100A and the cap substrate 100B are adapted to accommodate MEMS switch 113 in the state where nitrogen is sealed within a MEMS switch accommodating space section 124 constituted by the recessed portion 123 under bonded condition. Accordingly, since the MEMS switch element 113 is mounted into the MEMS switch accommodating space portion 124 in the state where moisture resistance characteristic and oxidation resistance characteristic are maintained, oxidation of respective components and/or sticking of the movable contact piece 136, etc. are prevented. Thus, improvement in durability and operating stability can be realized. As a result, it is possible to prevent high frequency loss and to form the entirety of the antenna by the compact structure.

At the tunable antenna 1 in the wireless communication system 10, the MEMS switch element 113 of the antenna board 100 where the organic base substrate 100A and the cap substrate 100B are bonded in this way is buried, and antenna element patterns 125A, 125B connected, through vias 126A, 126B, to the wiring patterns 120 formed on the organic base substrate 100A are formed as film on the cap substrate 100B.

In the wireless communication system 10, the first transmitting/receiving circuit 4 and the second transmitting/receiving circuit 5 are connected to the tunable antenna 1 through the duplexer 2 and the first and second transmit/receive changeover switches 3A, 3B.

The operations of the first and second transmit/receive changeover switches 3A, 3B are controlled by the system control unit 6 in a manner as described later.

As shown in FIG. 1, the first trtansmitting/receiving circuit 4 is composed of a digital control unit 40 and a RF front end unit 140 which employs Orthogonal Frequency Division Multiplexing (OFDM) system as modulation system for transmit data to perform data communication A in conformity with the IEEE802. 11a at carrier of 5.2 GHz band.

The digital control unit 40 is composed of a CPU41, a flash memory 42, a digital physical layer 43, and a MAC (Media Access Control) 44, etc., and serves to generate transmit data to send the transmit data thus generated to the RF front end unit 140, and to receive demodulated receive data from the RF front end unit 140.

The RF front end unit 140 is composed of a transmitting block 240, a receiving block 340 and a local oscillation block 440.

As shown in FIG. 1, the transmitting block 240 is composed of a data conversion unit 242 supplied with transmit data from the digital control unit 40 through a demultiplexer (DEMUX) 241, a D/A converting unit 243 connected to the data converting unit 242, a modulation unit 244 connected to the D/A converting unit 243, a power amplifier unit 245 supplied with modulated output of the modulation processing unit 244, and a distortion compensation processing unit (digital predistortion) 246 for compensating signal distortion taking place at the power amplifier unit 245, etc.

The data converting unit 242 serves to convert transmit data (time series data) delivered through the demultiplexer (DEMUX) 241 from serial data to parallel data to thereby allocate bits of the transmit data to respective carriers to be transmitted to perform Inverse-Fast Fourier Transform (I-FFT) to thereby transform the data thus obtained into data of time region.

The D/A converting unit 243 serves to convert transmit data of the time region allocated to respective carriers into analog signal by the data converting unit 242 to deliver the analog signal thus obtained to the modulation unit 244.

The modulation unit 244 modulates orthogonal carriers by the transmit data of the time region which has been converted into the analog signal by the D/A converting unit 243.

The power amplifier unit 245 serves to amplify orthogonally modulated signal obtained by the modulation unit 244. The orthogonally modulated signal which has been amplified by the power amplifier unit 245 is delivered to the tunable antenna 1 through the first transmit/receive changeover switch 3A and the duplexer 2.

It is to be noted that the distortion compensation processing unit 246 performs, in advance, distortion compensation processing for compensating signal distortion taking place in orthogonally modulated signal outputted from the power amplifier unit 245 with respect to transmit data of the time region which has been allocated to respective carriers.

Moreover, the receiving block 340 serves to perform processing opposite to that of the transmitting block 240, and is composed of a RF amplifier unit 341, a demodulation unit 342, an A/D converting unit 343, a data inverting unit 344, and a multiplexer (MUX) 345.

The RF amplifier unit 341 serves to amplify receive signal delivered, through the duplexer 2 and the first transmit/receive changeover switch 3A, from the tunable antenna 1 to deliver the signal thus obtained to the demodulation unit 342.

The demodulation unit 342 serves to multiply receive signal (orthogonally modulated signal) delivered from the RF amplifier unit 341 by orthogonal carriers to thereby modulate an analog signal of receive data of the time region in which bits are allocated to respective carriers.

The A/D converting unit 343 digitizes the analog signal of the receive data of the time region to thereby convert is into receive data of the time region to deliver the receive data thus obtained to the data inverting unit 344, and to deliver reception intensity signal (RSSI_A) indicated by amplitude value of analog signal of receive data of the time region to the system control unit 6.

The data inverting unit 344 converts receive data of the frequency region obtained by performing Inverse-Fast Fourier Transform (I-FFT) of receive data of the time region delivered from the A/D converting unit 343 from serial data to parallel data to deliver the parallel data thus obtained to the digital control unit 40 through multiplexer (DEMUX).

The local oscillation block 440 is composed of a voltage controlled oscillator (VCO) 441 for generating orthogonal two-phase signal of 5.2 GHz band, and a PLL circuit for performing PLL control of the VCO 441, and serves to deliver the orthogonal two-phase signal obtained by the VCO 441 to the modulation unit 244 of the transmitting block 240 as orthogonal carrier for transmission, and to deliver the orthogonal two-phase signal to the demodulation unit 342 of the receiving block 340 as orthogonal carrier for orthogonal modulation.

Moreover, the second transmitting/receiving circuit 5 is composed of a digital control unit 50 and a RF front end unit 150 which employ Orthogonal Frequency Division Multiplexing (OFDM) system as modulation system for transmit data to perform data communication B in conformity with the IEEE802. 11b at carrier of 2.4 GHz band.

The digital control unit 50 is composed of a CPU51, a flash memory 52, a digital physical layer 53, and a MAC (Media Access Control) 54, etc., and serves to generate transmit data to send the transmit data thus generated to the RF front end unit 150 to receive demodulated receive data from the RF front end unit 150.

The RF front end unit 150 is composed of a transmitting block 250, a receiving block 350, and a local oscillation block 450.

As shown in FIG. 1, the transmitting block 250 is composed of a data converting unit 252 supplied with transmit data from the digital control unit 50 through a demultiplexer (DEMUX) 251, a D/A converting unit 253 connected to the data converting unit 252, a modulation unit 254 connected to the D/A converting unit 253, etc, a power amplifier unit 255 supplied with modulated output of the modulation processing unit 254, and a distortion compensation processing unit (digital predistortion) 256 for compensating signal distortion taking place at the power amplifier unit 255, etc.

The data converting unit 252 serves to convert transmit data (time series data) delivered through the demoultiplexer (DEMUX) 251 from serial data to parallel data to thereby allocate bits of transmit data to respective carriers to be transmitted to perform Inverse-Fast Fourier Transform (I-FFT) to transform it into data of the time region.

The D/A converting unit 253 serves to convert transmit data of the time region which has been allocated to respective carriers into an analog signal by the data converting unit 252 to deliver the analog signal thus obtained to the modulation unit 254.

The modulation unit 254 modulates orthogonal carrier by transmit data of the time region which has been converted into analog signal by the D/A converting unit 253.

The power amplifier unit 255 amplifies orthogonally modulated signal obtained by the modulation unit 254.

Further, the orthogonally modulated signal which has been amplified by the power amplifier unit 255 is delivered to the tunable antenna 1 through the first transmit/receive changeover switch 3B and the duplexer 2.

It is to be noted that the distortion compensation processing unit 256 performs, in advance, distortion compensation processing for compensating signal distortion taking place in orthogonally modulated signal outputted from the power amplifier unit 255 with respect to transmit data of the time region which has been allocated to respective carriers.

In addition, the receiving block 350 serves to perform processing opposite to that of the transmitting block 250, and is composed of a RF amplifier unit 351, a demodulation unit 352, an A/D converting unit 353, a data inverting unit 354, and a multiplexer (MUX) 355.

The RF amplifier unit 351 amplifiers receive signal delivered, through the duplexer 2 and the second transmit/receive changeover switch 3B, from the tunable antenna 1 to deliver the signal thus obtained to the demodulation unit 352.

The demodulation unit 352 serves to multiply receive signal (orthogonally modulated signal) delivered from the RF amplifier unit 351 by orthogonal carriers to thereby demodulate an analog signal of receive data of the time region where bits are allocated to respective carriers.

The A/D converting unit 353 digitizes the analog signal of the receive data of the time region to thereby convert it into receive data of the time region to deliver the receive data of the time region to the data inverting unit 354, and to deliver reception intensity signal (RSSI_B) indicated by amplitude value of the analog signal of the receive data of the time region to the system control unit 6.

The data inverting unit 354 converts receive data of the frequency region obtained by performing Inverse-Fast Fourier Transform (I-FFT) of the receive data of the time region delivered from the A/D converting unit 353 from serial data to parallel data to deliver the receive data thus obtained to the digital control unit 50 through the multiplexer (MUX) 355.

The local oscillation block 450 is composed of a voltage controlled oscillator (VCO) 451 for generating orthogonal two-phase signal of 2.4 GHz band, and a PLL circuit 452 for performing PLL control of the VCO 451, and serves to deliver orthogonal two-phase signal obtained by the VCO 451 to the modulation unit 254 of the transmitting block 250 as orthogonal carrier for transmission, and to deliver the orthogonal two-phase signal to the demodulation unit 352 of the receiving block 350 as orthogonal carrier for orthogonal modulation.

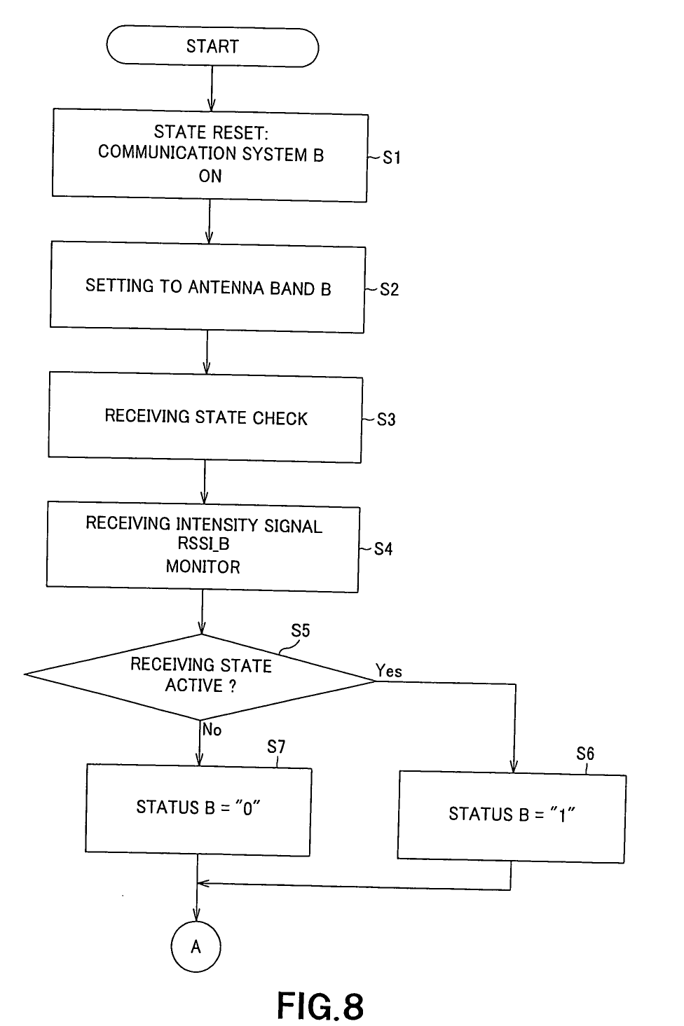

Further, the system control unit 6 controls the wireless communication system 10 in accordance with the procedure shown in the flowcharts of FIGS. 8 to 10.

First, as shown in FIG. 8, the system control unit 6 allows the entirety of the wireless communication system 10 to be in reset state thereafter to allow the operation mode to be communication mode in conformity with the IEEE802. 11b where data communication B is performed by the second transmitting/receiving circuit 5 (step S1) to allow control signals (cont1, cont2) to be turned ON to allow respective switches 13A, 13B of the tunable antenna 1 to be placed in closed state to thereby make a setting such that the tunable antenna 1 functions as λb/2 dipole antenna resonating at 2.4 GHz band used in data communication B in conformity with the IEEE802. 11b (step S2).

Further, the local oscillation block 440 of the second transmitting/receiving circuit 5 is controlled to perform frequency scan (step S3) to judge, while monitoring reception intensity signal (RSSI_B) of the second transmitting/receiving circuit 5 (step S4), whether or not data communication B in conformity with the IEEE802. 11b can be made (step S5).

In the case where judgment result at the step S5 is YES, i.e., data communication B in conformity with the IEEE802. 11b can be made, status B indicating available/non-available (usable/unusable) state of the data communication B in conformity with the IEEE802. 11b is caused to be “0” to store that status B into memory (step S6).

Moreover, in the case where judgment result at the step S5 is NO, i.e., data communication B in conformity with the IEEE802. 11b cannot be made, status B indicating available/non-available state of data communication B in conformity with the IEEE802. 11b is caused to be “0” to store that status B into memory (step S7).

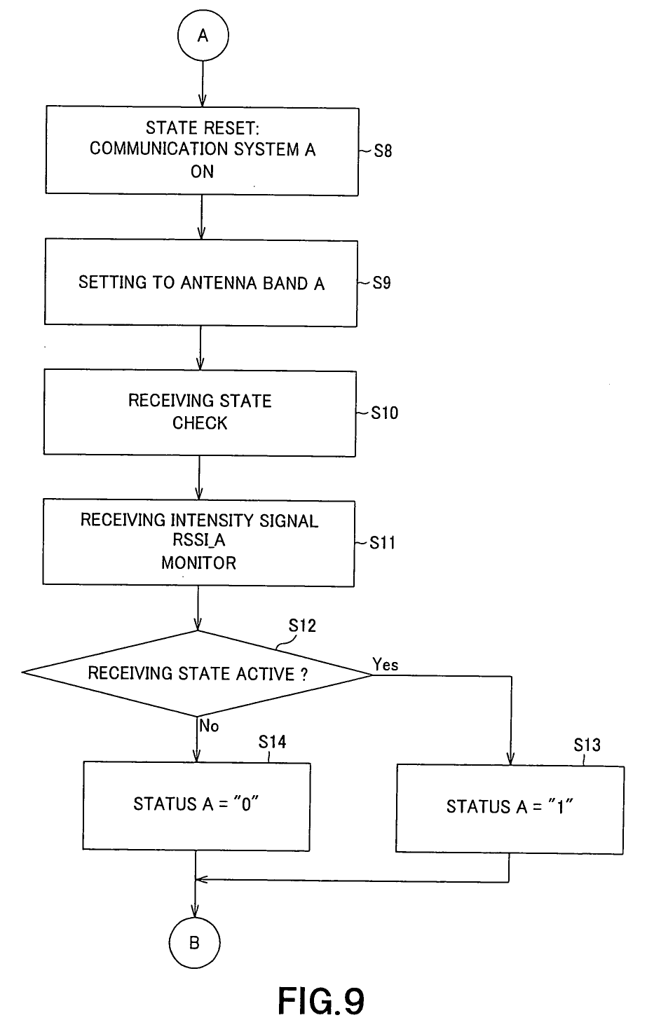

Then, as shown in FIG. 9, the system control unit 6 allows the entirety of the wireless communication system 10 to be in reset state to allow the operation mode to be communication mode in conformity with the IEEE802. 11a where data communication A is performed by the first transmitting/receiving circuit 4 (step S8) to allow control signals (cont1, cont2) to be turned OFF to allow respective switches 13A, 13B of the tunable antenna 1 to be placed in opened state to thereby make a setting such that the tunable antenna 1 functions as λa/2 dipole antenna resonating at 5.2 GHz band used for data communication A in conformity with the IEEE802. 11a (step S9).

Further, the local oscillation block 440 of the first transmitting/receiving circuit 4 is controlled to perform frequency Scan (step S10) to judge, while monitoring reception intensity signal (RSSI_A) of the first transmitting/receiving circuit 4 (step S11), whether or not data communication A in conformity with the IEEE802. 11a can be made (step S12).

In the case where judgment result at the step S12 is YES, i.e., data communication A in conformity with the IEEE802.11a can be made, status A indicating available/non-available state of the data communication A in conformity with the IEEE802. 11a is caused to be “0” to store that status A into memory (step S13).

Moreover, in the case where judgment result at the step S12 is NO, i.e., data communication A in conformity with the IEEE802. 11a cannot be made, status A indicating available/non-available state of the data communication A in conformity with the IEEE802. 11 a is caused to be “0” to store that status A into memory (step S14).

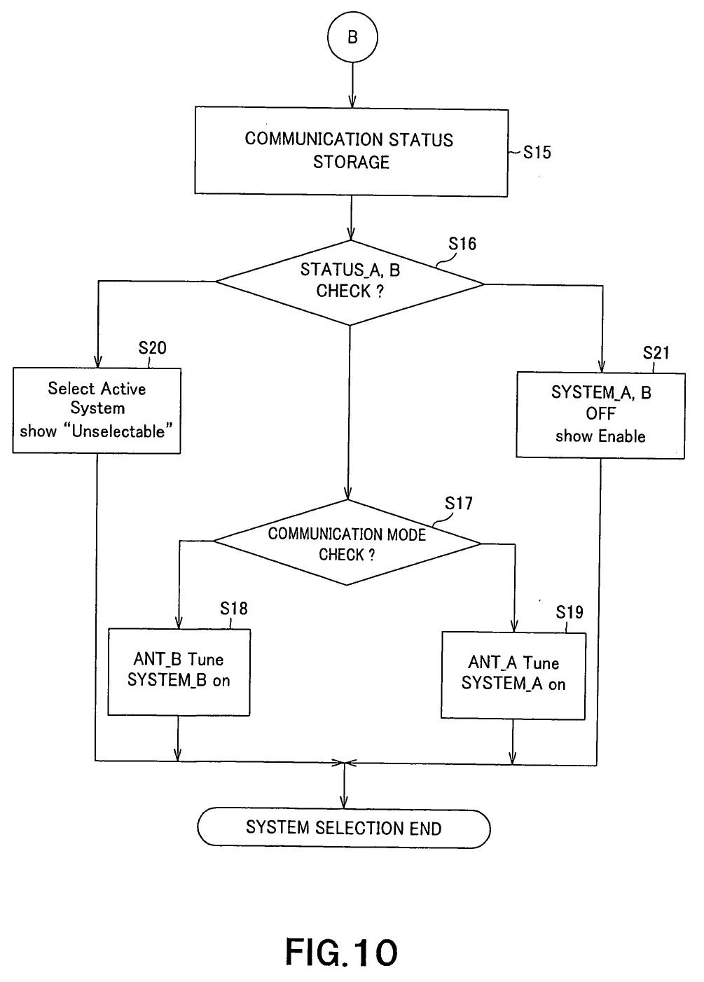

Further, as shown in FIG. 10, the system control unit 6 judges, in this way, available/non-available state of data communication A in conformity with the IEEE802. 11a and data communication B in conformity with the IEEE802. 11b to store, into memory, the status A and the status B which indicate the available/non-available state of data communication A and data communication B (step S15).

In addition, the system control unit 6 checks the status A and the status B which have been stored in the memory (step S16). When both the data communication A and the data communication B can be used, the system control unit 6 checks whether or not current state of the slave device is desired communication mode (power saving mode or high communication Rate mode) (step S17).

Further, when current communication mode that the slave device desires is power saving mode, the control signals (cont1, cont2) are caused to be turned ON to fix the communication mode to the receiving mode at the data communication B in conformity with the IEEE802. 11b (step S18).

Conversely, when setting such that high communication Rate mode is caused to be preferential is made, the control signals (cont1, cont2) are caused to be turned OFF to perform tuning so that receiving sensitivity of the tunable antenna 1 is set to 5.2 GHz band thereafter to set the communication mode to the receiving mode at the data communication A in conformity with the IEEE802. 11a (step S19).

Moreover, in the case where only either one of data communications can be used as the result of the fact that the status A and the status B are checked at the step S16, the system control unit 6 serves to compulsorily fix the communication mode to usable communication system to display a notification that current communication mode is compulsory mode (step S20).

Further, in the case where both data communications cannot be used, the system control unit 6 displays that data communication cannot be used to allow the communication to be turned “OFF” (step S21).

In the wireless communication system 10, control signals (cont1, cont2) are generated at the system control unit 6 on the basis of reception intensity signals (RSSI signals) obtained by respective transmitting/receiving circuits 4, 5 to switch the operation mode, thereby making it possible to automatically select reasonable communication mode to perform data communication.

It should be noted that the previously described available/non-available state of two data communication systems may be monitored, e.g., at specific time interval, whereby when either one communication system is placed in unusable state for any cause, e.g., when waking is made from the sleep mode and/or the state is reset, etc., switching into either one usable system can be also automatically performed.

While the example where communication system of 2 (two) bands is switched has been illustrated in the above-described explanation, there may be employed, even in the case of three bands or more, an approach to check and monitor the communication state by similar technique, and to also trisect the antenna so that switching can be made by MEMS switch elements, thereby making it possible to easily construct automatic tuning mechanism.

It is to be noted that while the example where MEMS switch elements 113A, 113B are applied as switches 13A, 13B for switching resonance frequency of the antenna has been illustrated, it is a matter of course that switching of resonance frequency of the antenna may be realized even by ordinary active element switches using diodes or transistors without any inconvenience except that elevation of power consumption is feared.

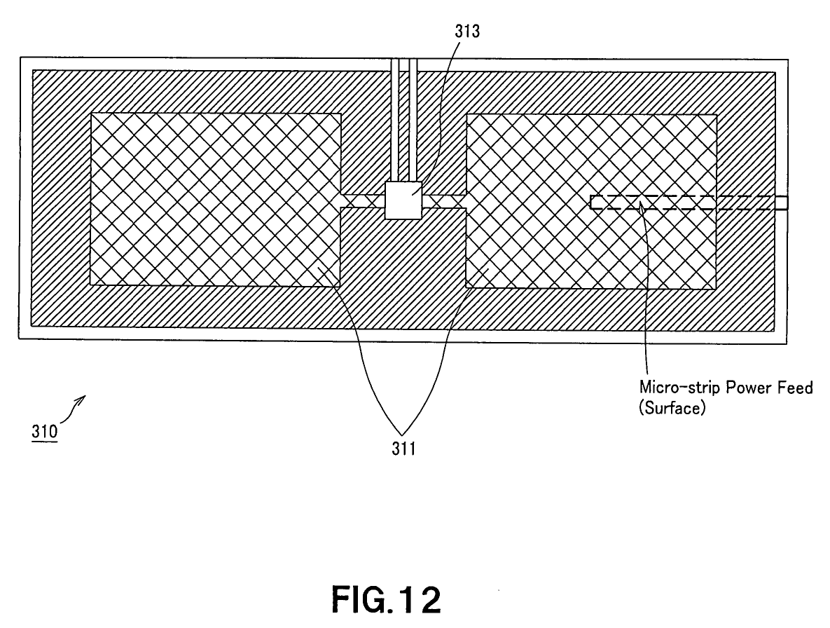

Moreover, while λ/2 dipole antenna including folded pattern-shaped antenna element patterns 111A, 111B, 112A, 112A, 112B is used as the tunable antenna 1 in the above-described example, e.g., the length of antenna element pattern 211 may be switched by MEMS switch element 213 at inverted F-type mono-pole antenna 210 as shown in FIG. 11 to change resonance frequency, or antenna element patterns 311 may be switched by MEMS switch element 313 at micro-strip fed slot type antenna 310 as shown in FIG. 12 to change resonance frequency.

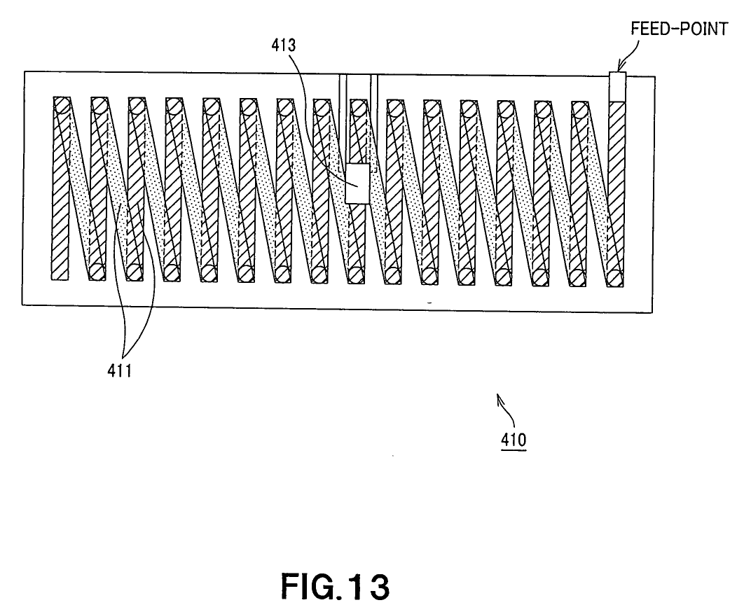

Further, the multi-layer structure of multi-layer printed wiring board may be utilized to constitute antenna of three-dimensional structure to perform switching by MEMS switch elements. For example, as shown in FIG. 13, resonance frequency may be switched by MEMS switch element 413 at mono-pole antenna 410 having antenna patterns 411 of spiral shape formed by making use of multi-layer structure of the multi-layer printed wiring board.

It is to be noted that the present invention has been described in accordance with certain preferred embodiments thereof illustrated in the accompanying drawings and described in detail, it should be understood by those ordinarily skilled in the art that the invention is not limited to embodiments, but various modifications, alternative constructions or equivalents can be implemented without departing from the scope and spirit of the present invention as set forth by appended claims.

### INDUSTRIAL APPLICABILITY

As described above, in accordance with the present invention, troublesomeness in which plural communication systems are used while performing selective switching thereof can be eliminated. Thus, user can select and use communication system corresponding to the environment and/or use state at that place without becoming conscious that any communication is used.

In addition, in the present invention, MEMS switch elements are included within the printed wiring board, thereby making it possible to provide compact configuration with low power consumption.

1. A wireless communication antenna including plural antenna element patterns connected through a switch or switches formed on an antenna board, and
having plural resonance frequencies selected by switching connecting state of the antenna element patterns by the switch or switches.

2. The wireless communication antenna as set forth in claim 1,
wherein the switch is comprised of MEMS (Micro-Electro-Mechanical-System) switch element, and is buried in the antenna board comprised of multi-layer substrate.

3. A wireless communication apparatus comprising:
a wireless communication antenna including plural antenna element patterns connected through a switch or switches formed on an antenna board, and having plural resonance frequencies selected by switching connecting state of the antenna element patterns by the switch or switches;
plural communication circuits having communication bands different from each other, which are connected to the wireless communication antenna; and
a control unit for performing, in accordance with a communication band used, a control to select the communication circuit, and to select the resonance frequency of the wireless communication antenna.

4. The wireless communication apparatus as set forth in claim 3,
wherein the control unit performs a control to automatically determine the communication band used in accordance with operation mode which can be set in advance to select the communication circuit, and to select the resonance frequency of the wireless communication antenna.

5. The wireless communication apparatus as set forth in claim 3,
wherein the control unit performs a control to automatically determine the communication band used on the basis of signal reception intensities obtained from the respective communication circuits to select the communication circuit, and to select resonance frequency of the wireless communication antenna.

6. The wireless communication apparatus as set forth in claim 3,
wherein the switch of the wireless communication antenna is comprised of MEMS switch element, and is buried in the antenna board comprised of multi-layer substrate.
